(19) United States
(12) Patent Application Publication
(10) Pub. No.: US 2018/0218463 A1
(43) Pub. Date: Aug. 2, 2018

(54) Dynamic Tracking and Control of Passenger Travel Progress

(71) Applicant: British Airways Plc, West Drayton (GB)

(72) Inventor: Daniel JOBLING, West Drayton (GB)

(21) Appl. No.: 15/128,945

(22) PCT Filed: Mar. 24, 2015
(86) PCT No.: PCT/GB2015/050879

§ 371 Date: Sep. 23, 2016

(30) Foreign Application Priority Data
Mar. 24, 2014 (GB) 1405206.2

(51) Int. Cl. G06Q 50/14; G06Q 10/02; H04W 4/029

(52) U.S. Cl. CPC G06Q 50/14; H04W 4/029; G06Q 10/025

(57) ABSTRACT

A system and method for dynamic travel path planning are disclosed. The system retrieves data defining a customer's journey including at least one scheduled flight to or from a configured airport terminal that includes a plurality of customer locating means. Planning data is received from a plurality of predefined data sources, including customer location data and environment data. The system determines schedule data defining a dynamic travel path for the customer's journey based on received planning data. The system identifies a disruption to the dynamic travel path based on received planning data and updates the schedule data by adjusting the timing parameters of affected journey segments and key events based on received planning data. The schedule data is transmitted to the customer's mobile device for display as an interactive interface.

### FIELD OF THE INVENTION

The present invention relates to systems and methods for passenger tracking, and more particularly to monitoring passenger travel progress along a dynamic journey and controlling aspects to influence the progress.

### BACKGROUND OF THE INVENTION

Travel route planning, monitoring and optimisation systems are generally known, for example that find an ideal route from a departure point to a destination point, detect or predict disruptions along the travel route, and notify the passenger of alternative routes or route segments, as discussed for example in US-20040039614 and EP2217880.

It is also known to guide passengers to defined zones and locations within an airport terminal, as discussed for example in U.S. Pat. No. 8,498,810 and GB2499288.

Such known systems perform planning and provide guidance in relation to predefined segments of a customer's travel path to a destination point, and leave much room for improvements to accuracy and completeness of planning and guidance for the customer's end to end journey.

What is desired is an improved system that enables more robust, complete and accurate monitoring of a customer's travel progress to facilitate greater efficiency in tracking and guidance aspects and components of the overall passenger travel ecosystem.

### STATEMENT OF THE INVENTION

Aspects of the present invention are set out in the accompanying claims.

According to one aspect of the present invention, a system is provided for dynamic travel path planning, comprising means for retrieving stored data defining a customer's journey from a departure location to a destination location, the journey including at least one scheduled flight to or from a configured airport terminal, wherein the configured airport terminal includes a plurality of customer locating means provided at respective locations of the configured airport terminal; means for receiving planning data from a plurality of predefined data sources, including location data from a mobile device associated with the customer, location data from said plurality of customer locating means identifying a location of the customer in the configured airport terminal, and environment data from at least one external data source; means for determining schedule data defining a dynamic travel path for the customer's journey based on received planning data, the dynamic travel path including a plurality of journey segments and key events along a timeline, each journey segment and key event associated with at least one timing parameter; means for identifying a disruption to the dynamic travel path based on received planning data and for identifying one or more affected journey segments and key events of the dynamic travel plan; means for updating the schedule data by adjusting the timing parameters of the affected journey segments and key events based on received planning data; and means for transmitting the schedule data to the customer's mobile device for display as an interactive interface.

Preferably, the customer locating means comprise a plurality of mobile device sensors and interactive display stations located throughout the airport terminal. The at least one database may store data identifying the plurality of mobile device sensors and interactive display stations, and a respective associated location. The mobile device sensors may be configured to transmit data to the server in response to detection of the customer's mobile device by a sensor. The interactive display stations may be configured to transmit data to the server in response to identification of the customer or the customer's mobile device interacting with a station.

The environment data may include data relating to a specific geographical location or area. For example, the environment data may include data relating to road traffic incidents and delays, public transport incidents and delays, and weather incidents. The environment data may include data relating to queue lengths and waiting times of respective locations throughout the airport terminal. The schedule data may be updated by determining the availability of environment data for a geographical location associated with each journey segment of the optimal travel path, whereby accuracy of the schedule data depends on the determined availability of environment data.

The timing parameters may comprise an anticipated start time and duration. The server may further comprise means for determining that the updated schedule data results in insufficient time for the customer to board the scheduled flight, and in response, for identifying an alternative flight. The server may further comprise means for automatically rebooking the customer on the alternative flight, and wherein the updating means is operable to update the schedule data based on the rebooked flight.

The journey segments may include a segment that is associated with a travel path from the departure location to the configured airport terminal for a scheduled flight. The server may further comprise means for determining at least one suggested route for that journey segment. The at least one suggested route includes driving instructions from the departure location to the configured airport terminal, and/or routing instructions using public transport from the departure location to the configured airport terminal.

The server may further comprise means for generating and transmitting auxiliary information to guide the customer from the departure location to a boarding gate at configured airport terminal assigned to the scheduled flight.

According to one aspect of the present invention, a system is provided for dynamic travel path planning for a customer's journey from a departure location to a destination location, comprising means for receiving location data identifying a geo-location of the customer and environment data from at least one external data source relating to the customer's current and anticipated geo-locations, and means for determining and updating schedule data defining a dynamic travel path for the customer's journey based on received location and environment data, based on selection of one of a plurality of tiered travel paths of varying complexity, depending on the availability of location and environment data at the customer's current and anticipated geo-locations.

In yet another aspect, there is provided a system for dynamically determining an optimal travel path depending on the availability of a plurality of predefined data sources. The optimal travel path may include information to guide the customer from a departure point, such as a home location, to an assigned boarding gate at an airport terminal. Additionally, the system is configured to generate and provide a dynamic timeline for display by a mobile device, indicating key events along the timeline and associated timing aspects, which are adjusted as information from the plurality of predefined data sources are received. The data sources include tracking data from the customer's mobile device on route to the airport terminal, and sensor data from a plurality of sensors located throughout the airport terminal. On the basis of information from the predefined data sources, the system determines if the customer has sufficient time to board the flight, and if not, to suggest an alternative flight.

In other aspects, there are provided methods of operating the systems as described above. In another aspect, there is provided a computer program comprising machine readable instructions stored thereon arranged to cause a programmable device to become configured as a system as described above.

### BRIEF DESCRIPTION OF THE DRAWINGS

Specific embodiments of the invention will now be described, purely by way of example, with reference to the accompanying drawings in which:

FIG. 1 is a schematic diagram of a tracking and guidance system according to an embodiment of the invention.

FIG. 2 is a schematic diagram of a mobile device for use in embodiments of the invention.

FIG. 3 is a schematic diagram of the server in FIG. 1 according to an embodiment.

FIG. 4 is a schematic block diagram illustrating an exemplary arrangement of mobile device sensors in and around an airport terminal.

FIG. 5, which comprises FIGS. 5A and 5B, is a flow diagram illustrating processing steps performed by the tracking and guidance system of FIG. 1 according to an embodiment.

FIG. 6 schematically illustrates an example of an initial view of an interactive travel path displayed by a mobile device, according to the embodiment.

FIG. 7 schematically illustrates an example of a zoomed-in view of the interactive travel path in FIG. 6, according to the embodiment.

FIG. 8, which comprises FIGS. 8A and 8B, is a flow diagram illustrating processing steps performed by the tracking and guidance system of FIG. 1 to dynamically adjust a travel path in response to identified disruptions, according to the embodiment.

FIG. 9 schematically illustrates an example of an updated version of the travel path in FIG. 7A, according to the embodiment.

FIG. 10, which comprises FIGS. 10A and 10B, schematically illustrates another example of a zoomed-in view of an updated travel path, according to the embodiment.

FIG. 11 is a diagram of an example of a computer system for use in embodiments of the invention.

### DETAILED DESCRIPTION OF EMBODIMENTS

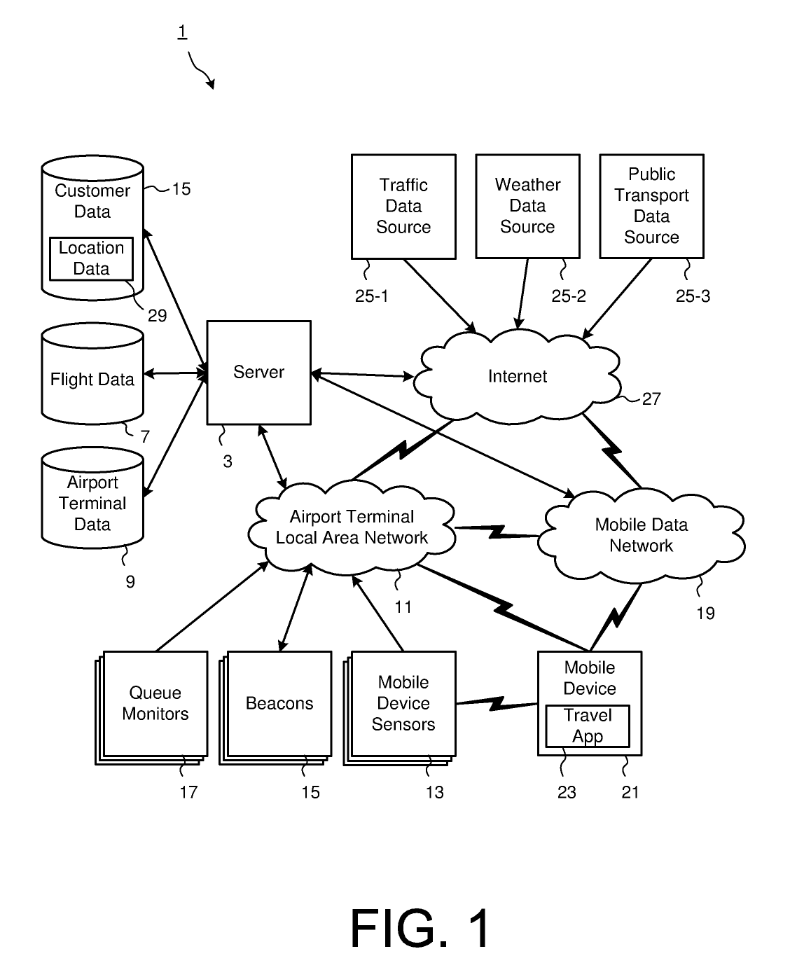

FIG. 1 shows schematically the elements of a tracking and guidance system in an embodiment of the invention that relates to commercial air travel. Aspects of the invention may be applicable to other travel environments. At least some of the elements are optional, at least for certain applications.

In this embodiment, an automated system accesses customer location data relating to a present or last known geographical location of a customer who has booked a flight with the system, for example from location tracking information received from the customer's mobile device and from sensors located throughout the airport terminal. On the basis of these inputs, the system is able to determine an optimal travel path for display by the mobile device, indicating key events along the timeline and associated timing aspects, and to dynamically suggest adjustments to the travel path in response to identified disruptions. Specific examples and applications will be described below.

In the system 1 shown in FIG. 1, a server 3, or more generally a service, has access to customer data 5, flight data 7 and airport terminal data 9, for example from one or more local and/or remote databases. The customer data 5 may comprise customer biometric details such as age, gender, height, weight, etc., health status, and personal preferences, such as dietary requirements, sleeping habits etc. The customer data can also include other elements identifying the journey type (such as business or leisure travel) and/or the size and composition of other traveling members of an associated group of passengers, which can be used by the system 1 to further personalize and adapt the travel path for respective associated customers and/or groups. For example, the system can be configured to determine and provide event triggers or notifications when a customer is near an airport lounge based on whether a customer has access to the airport lounge, and/or to provide indication of children's activities/areas at the airport for a family that is traveling together.

The customer data 5 may be provided by customer input, for example within a travel app 23 running on the customer's mobile device 21 or via a web-based interface, or may be provided from a user profile within another service with which the user is registered, such as a social network. The customer data 5 also comprises location data 29 relating to the current or last-known geographical location of the customer or the customer's mobile device 21, for example from location tracking information received from the customer's mobile device 21. The customer data 5, flight data 7 and/or airport terminal data 9 may also be stored in the customer mobile device 21, and may be updated when the travel app 23 is connected to the server 3.

The flight data 7 is linked to the customer data 5 and includes data relating to flights that the customer has booked, checked in for, or boarded. The flight data 7 includes the timing and duration of the flight, as well as the departure and arrival points of the flight, and information of any connecting flights. The flight data 7 may also include information associated with in-flight aspects, such as meal and/or cabin lighting schedules for the specific flight, as well as information associated with offers for the customer, such as available flight upgrades. The airport terminal data 9 includes data relating to departure and arrival airport terminals of the flights that the customer has booked or purchased. The terminal data 9 includes current and anticipated information of assigned gates and flight boarding status, assigned baggage claim belts or areas, and flight transfers, terminal maps and information on services and locations within and around the terminal.

The server 3 is in communication with one or more airport terminal networks 11, which connect the server 3 to a plurality of mobile device sensors 13, beacons 15 and/or queue monitors 17 located at respective predefined areas of the airport terminal. The airport terminal network 11 may be a wired or wireless network. The mobile device sensors 13 may be any type of known sensors suitable for indoor location-based computing of mobile devices, such as low-cost Bluetooth mobile positioning sensors that can scan and detect mobile devices in Bluetooth discoverable mode. The queue monitors 17 may be any type of known live queue detection and monitoring module suitable for monitoring and counting the number of people entering and leaving an associated area and/or queue.

The beacons 15 may be multi-purpose interactive stations, such as computer terminals, televisions or tablet computing devices with touchscreen displays. The beacons 15 may vary in size and function, each station being configurable for respective requirements for example based on the demographic of the customer base and the uniqueness of the services and facilities available at the associated airport terminal. The beacons 15 may be configured to assist a customer with wayfinding and orientation within the airport terminal. The beacons 15 may also be configured to detect and recognise a customer, for example based on interactions by the customer with the station and/or via data communicated to and from the mobile device 21.

The server 3 can update a customer's location data 29 based on information received from sensors 13 in the airport terminal that detect the customer's mobile device 21, and from customer interactions with the beacons 15 in the airport terminal. The terminal data 9 may also include information associated with the location of beacons 15 in and around the airport terminal, and the state of queues at respective locations in the airport terminal.

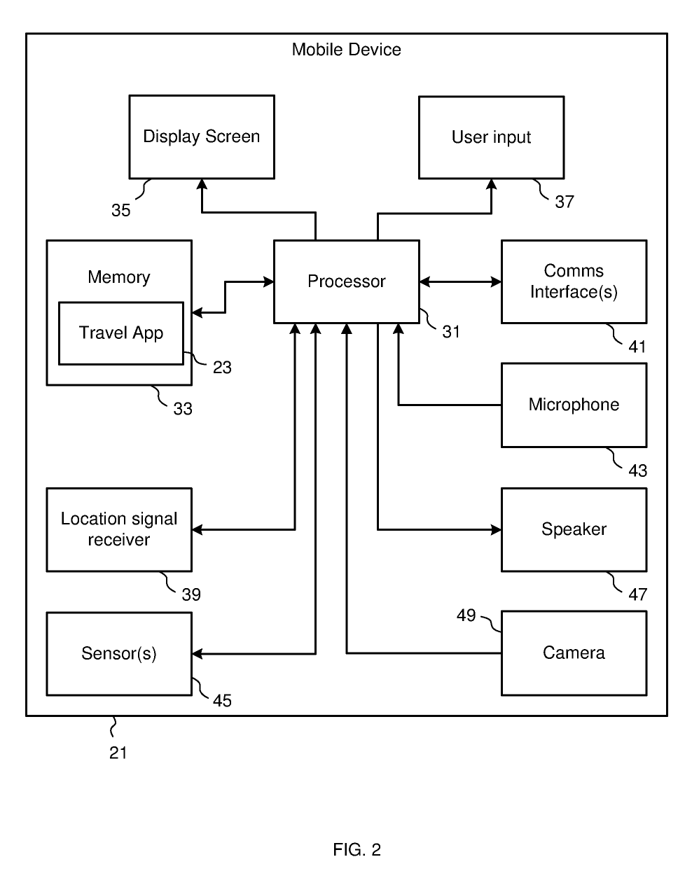

The server 3 may also be connected to a mobile data network 19, for communication with mobile devices 21, such as a customer's mobile device. In this embodiment, the customer mobile device 21 stores and runs a travel app 23, that enables the customer to interact with the server 3, for example to retrieve flight data 7, book and purchase new flights, access customer data 5, display and interact with the dynamic travel path, etc. The mobile device 21 may be a smartphone, tablet, smart watch, PDA (Personal Digital Assistant), or a wearable device such as Google Glass™. FIG. 2 is a schematic diagram of one such exemplary mobile device 21, having a processor 31, memory 33, a display screen 35, user input module 37, a location signal receiver 39 and communications interface(s) 41. The location signal receiver 39 may be a GPS based receiver for determining a geolocation of the mobile device 21. The mobile device 21 may also include one or more of: a microphone 43, one or more sensors 45, a speaker 47 and a camera 49. The travel app 23 may be downloaded and installed to the memory 33 of the mobile device 21, and may require registration of the customer with the server 3 via the app, or secure log-in to the app by an existing customer registered with the server 3. The travel app 23 may be configured to run in the background, to collect and provide information to the server 3 on an ongoing basis, and to receive and process push updates and event triggers from the server 3.

The server 3 is also connected to a plurality of third-party data sources 25 via the Internet 27, such as a traffic data source 25-1, a weather data source 25-2, and a public transport data source 25-3. Such third-party data sources 25 are well-known and readily available from one or more third-party vendors. Traffic data may include crowd-sourced traffic update information. The availability, quality and granularity of traffic data, weather data and/or public transport data will vary depending on the particular geographical location. For example, larger cities are more likely to have publicly available real-time transport performance information that the system 3 can interface with via the Internet 27. On the other hand, smaller cities may provide poorer access to less accurate data, or may not provide any transport information at all. The server 3 may also be connected to one or more other types of third-party data sources to retrieve additional information for use in tracking the customer or dynamically adjusting the optimal travel path.

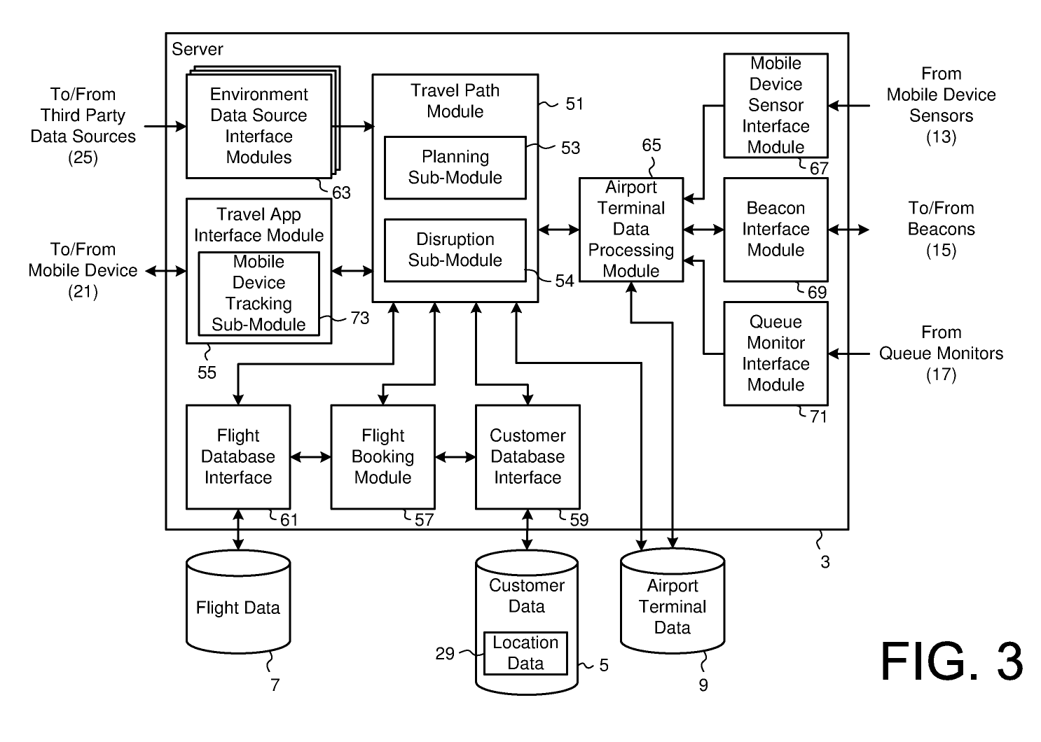

FIG. 3 is a schematic diagram of the server 3, illustrating the processing modules of the server 3 in this embodiment. The server 3 includes a travel path module 51 for generating an optimal travel path for a customer having a booked and/or purchased journey, including various booked entities such as an outbound flight from the customer's home location to a destination location, a hotel reservation at the destination location, a return flight, etc. In this embodiment, the optimal travel path for the customer's booked journey is an end-to-end plan, consisting of a plurality of journey segments from a departure point, such as the customer's home location, to a destination point, such as a boarding gate in the departure airport terminal assigned to the customer's flight or the location of a hotel booked in the destination city. The travel path module 51 processes customer data 5, flight data 7, and/or airport terminal data 9 to identify and determine the journey segments, as well as associated timing parameters, such as anticipated start time, duration, etc., using a planning sub-module 53. The travel path module 51 can also determine and schedule predefined key events associated with the journey segments. The travel path module 51 is also configured to dynamically revise and update the travel plan based on the monitored geographical location of the customer together with environmental information retrieved from a plurality of data sources.

In this embodiment, the travel path generator module 53 generates data for a graphical user interface (GUI) representation of the optimal travel path, for example based on scheduling data determined by the planning sub-module 53. The generated travel path data is communicated to the travel app 23 on the mobile device 21, via a travel app interface module 55. Additionally, the travel app interface module 55 can receive and process data in response to customer input via the travel app 23 to search for and retrieve flight data 7, book or purchase a new flight, re-book a flight at a new time and/or date, etc. The generated travel path data may define an interactive graphical representation of the optimal travel path to be displayed by the travel app 23. Alternatively, the generated travel path data may define user-selectable elements of the optimal travel path, associated with the scheduled key events for example, for display by the travel app 23 based on one or more predefined travel path GUI templates. As yet a further alternative, the generated travel path data may consist of scheduling data elements in a structured data format, such as XML, CSV, etc. The planning sub-module 53 may be provided as a separate component from the planning module 51.

As will be described in more detail below, the planning sub-module 53 of the travel path module 51 schedules a plurality of predefined key events associated with the plurality of journey segments depending on one or more predetermined factors, such as event order, start time, end time, duration. The planning sub-module 53 also re-schedules key events that are determined to be impacted by one or more identified disruptions. In this embodiment, disruptions are identified by a disruption sub-module 54, for example based on information received from one or more third party data sources 25 and/or processed airport terminal data 9, such as information from one or more queue monitors 17. For example, the planning sub-module 53 can determine that the customer will not have sufficient time to travel from a present geographical location to an assigned boarding gate in the departure airport terminal due to an identified disruption and delay to the public transport journey segment of the optimal travel path. In response, the travel path module 51 can alert the customer, for example via the travel app 23, determine and present one or more alternative flights for the customer, and automatically re-book a selected alternative flight. The server 3 includes a flight booking module 57 for automatically booking a new flight for the customer and storing the resulting Passenger Name Record (PNR) for the flight reservation in the customer data 5. Similarly, the planning sub-module 53 can determine that the customer will not have sufficient time to make a subsequent connecting flight, and the flight booking module 57 can automatically re-book a new connecting flight at a suitable time, taking into account the calculated delay.

It will be appreciated that the system 3 can be further configured to determine that an identified disruption will affect other pre-booked services, such as hotel, car hire and other third party ancillaries, and to automatically re-book the affected services for the customer, taking into account the calculated delay. As another example, the system 3 can be configured to determine that an identified disruption will affect other customers on the scheduled flight and to automatically trigger actions, such as unloading of affected standby customers, pre-planning of available upgrades, generating an automatic service recovery to immediately credit the customer with frequent flyer points/rewards due to delays, etc.

The travel path module 51 accesses customer data 5 via a customer database interface 59, for example to retrieve stored location data 29 and other details associated with the customer. The travel path module 51 also retrieves flight data 7 for a booked and/or purchased flight, via a flight database interface 61. The travel path module 51 and the travel path generator module retrieve information from the plurality of third-party data sources 25 via one or more respective third party data source interface modules 63, for example to retrieve traffic data, weather data and public transport data. The travel path module 51 also determines whether each of the plurality of third-party data sources 25 is available for the customer's current, anticipated and/or destination locations. Based on the determined availability of data sources 25, the travel path module 51 dynamically varies the scope or breadth of key events and services that are taken into account when determining and generating the customer's optimal travel path.

The travel path module 51 also retrieves airport terminal data 9, for example via an airport terminal data processing module 65. The airport terminal data processing module 65 receives data from the mobile device sensors 13, beacons 15 and queue monitors 17 in the departure and/or arrival airport terminal, via respective interface modules 67, 69, 71. The travel path module 51 can also update the location data 29 in the customer data 5, for example based on location tracking information received from the customer's mobile device 21 via a mobile device tracking sub-module 73 of the travel app interface module 55, from location information associated with sensors 13 in the airport terminal, for example when the customer's mobile device 21 is detected by one or more mobile device sensors 13, and from location information associated with beacons 15 in the airport terminal, for example when the customer interacts with a beacon 15. It will be appreciated that information identifying the geolocation of the mobile device can be obtained instead, or additionally, from one or more third-party data sources 25, such as a third-party GPS tracking service.

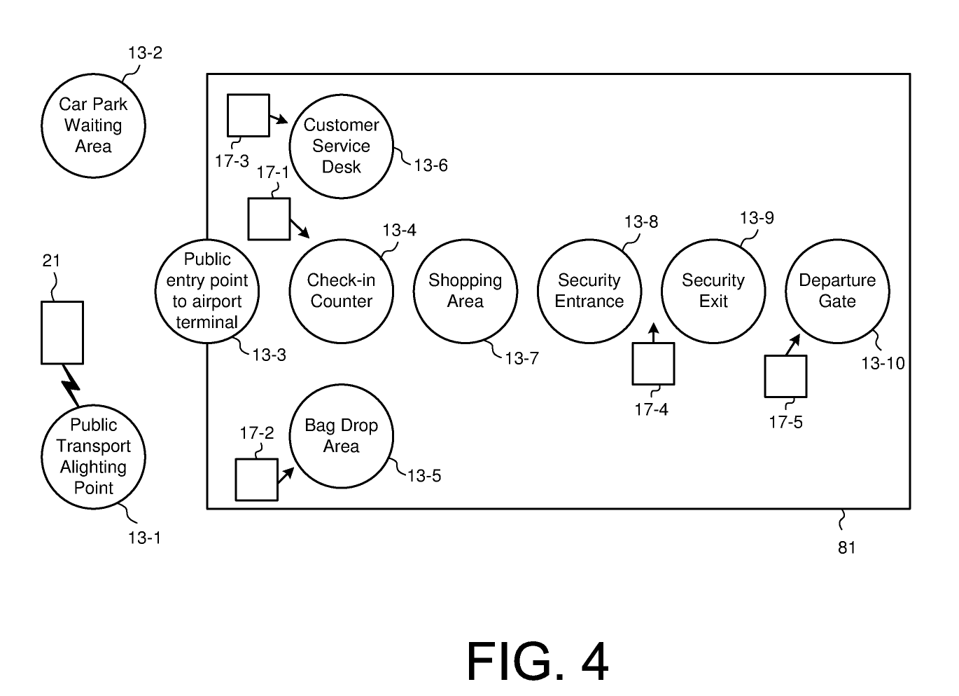

FIG. 4 is a schematic block diagram illustrating an arrangement of mobile device sensors 13 in and around an exemplary airport terminal 81. As indicated in FIG. 4, each of the plurality of mobile device sensors 13 is associated with a predefined location, area or region of the terminal 81, that together enable the server 3 to monitor and track the location and progress of a customer arriving to and travelling through the airport terminal 81, as the customer's mobile device 21 is detected at respective ones of the mobile device sensors 13. In the exemplary airport terminal 81 illustrated in FIG. 4, the sensors 13 are located at:
one or more public transport alighting points 13-1, to detect when the customer has arrived at the terminal 81 by public transport (e.g. bus or train),
one or more car park waiting areas 13-2, to detect when the customer has arrived by car or taxi,
one or more public entry points 13-3, to detect when the customer has entered the airport terminal 81 building via a respective entrance or doorway,
one or more check-in counters 13-4, to detect when the customer is approaching or at a respective numbered or labelled check-in counter, or an automated boarding pass and/or bag tag printer kiosk for automatic check-in,
one or more bag drop areas 13-5, to detect when the customer is approaching or at a respective bag drop counter or area,
one or more customer service desks 13-6, to detect when the customer is approaching or at a customer service desk,
one or more shopping areas 13-7, to detect when the customer is located within a respective shop or shopping area,
one or more security entrances 13-8, to detect when the customer is approaching or at an entrance to a respective security check-point,
one or more security exits 13-9, to detect when the customer has passed through a respective security check-point, and
one or more departure gates 13-10, to detect when the customer is approaching or at a respective departure gate, such as the boarding gate assigned to the customer's next flight.

Also illustrated in FIG. 4 are a plurality of queue monitors 17 also located in the exemplary airport terminal 81. Each queue monitor 17 is also associated with a predefined location, area or region of the terminal 81, to provide information identifying parameters of the queue of people waiting in the respective location, area or region, such as queue length, wait time, flow rate, etc. In the exemplary airport terminal 81 illustrated in FIG. 4, one or more queue monitors 17-1 monitor the queue(s) at respective check-in counters, one or more queue monitors 17-2 monitor the queue(s) at respective bag drop areas, one or more queue monitors 17-3 monitor the queue(s) at respective customer service desks, one or more queue monitors 17-4 monitor the queue(s) at respective security areas, and one or more queue monitors 17-5 monitor the queue(s) at respective departure gates.

Customer Tracking Process

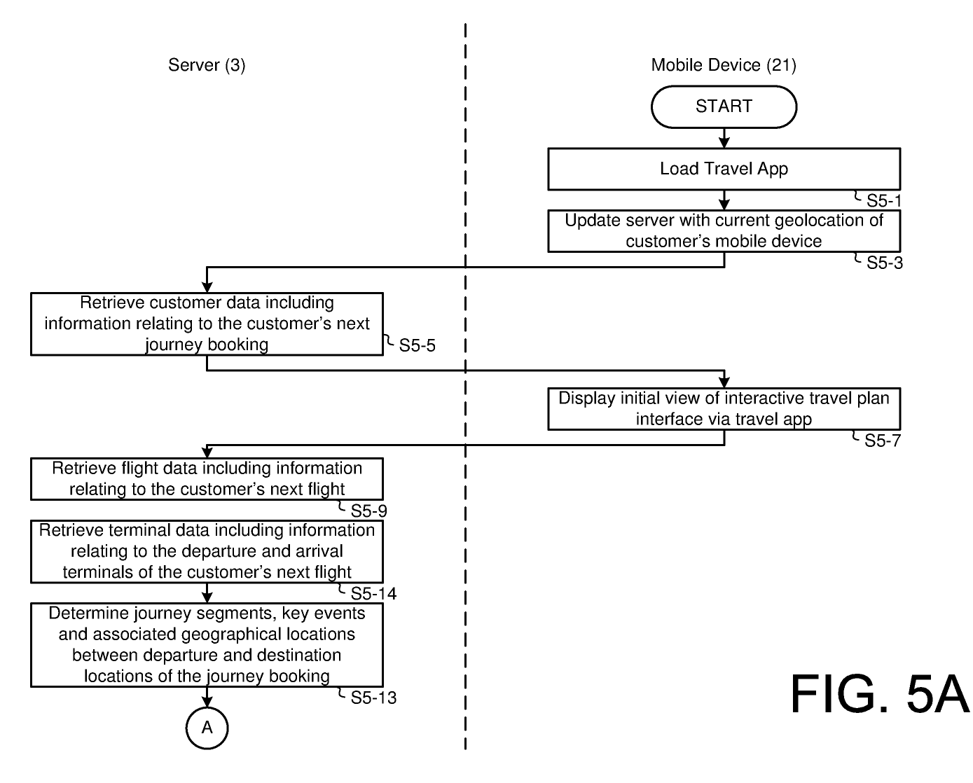

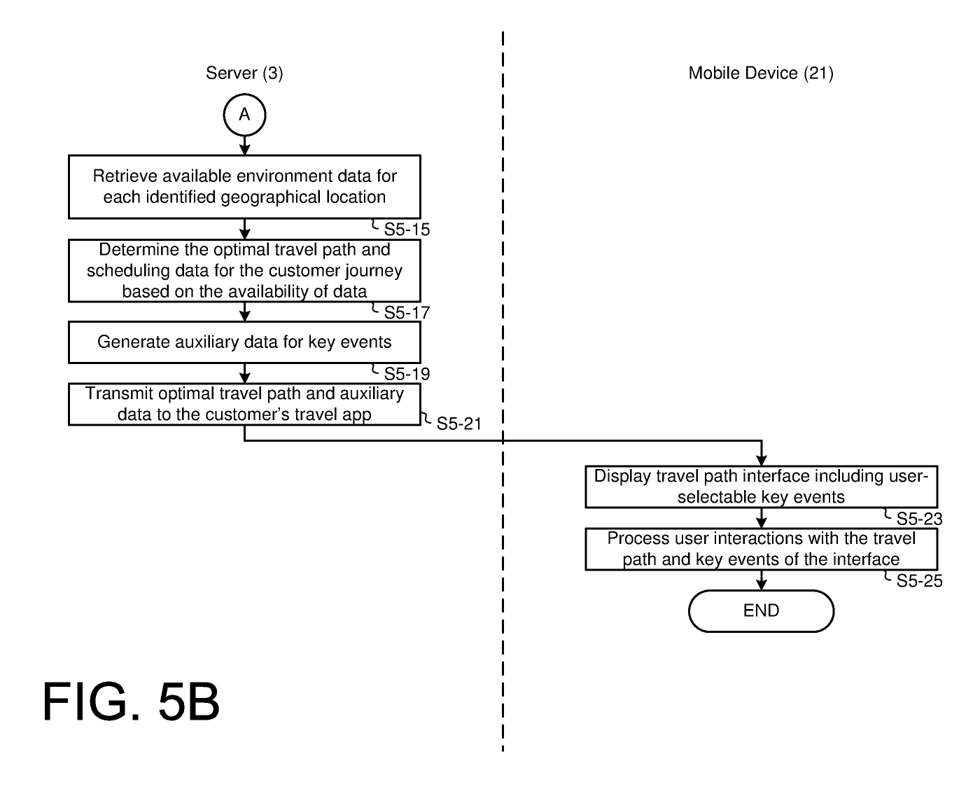

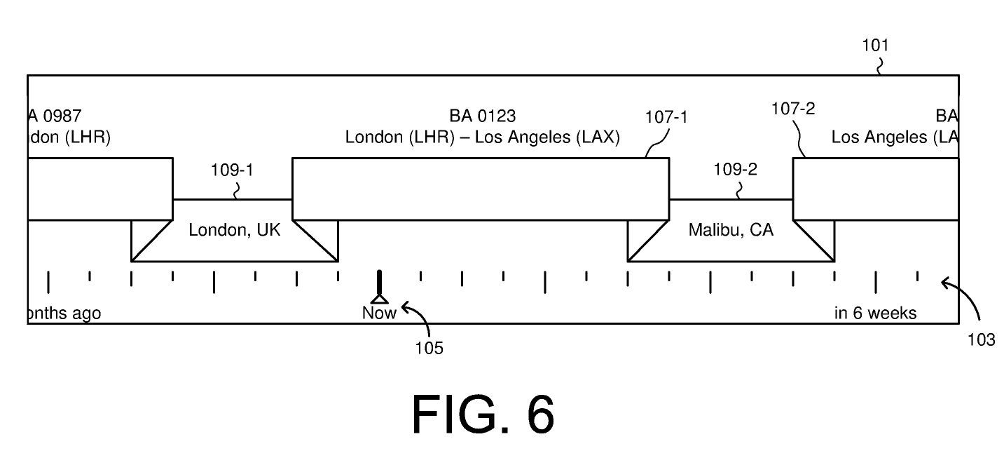

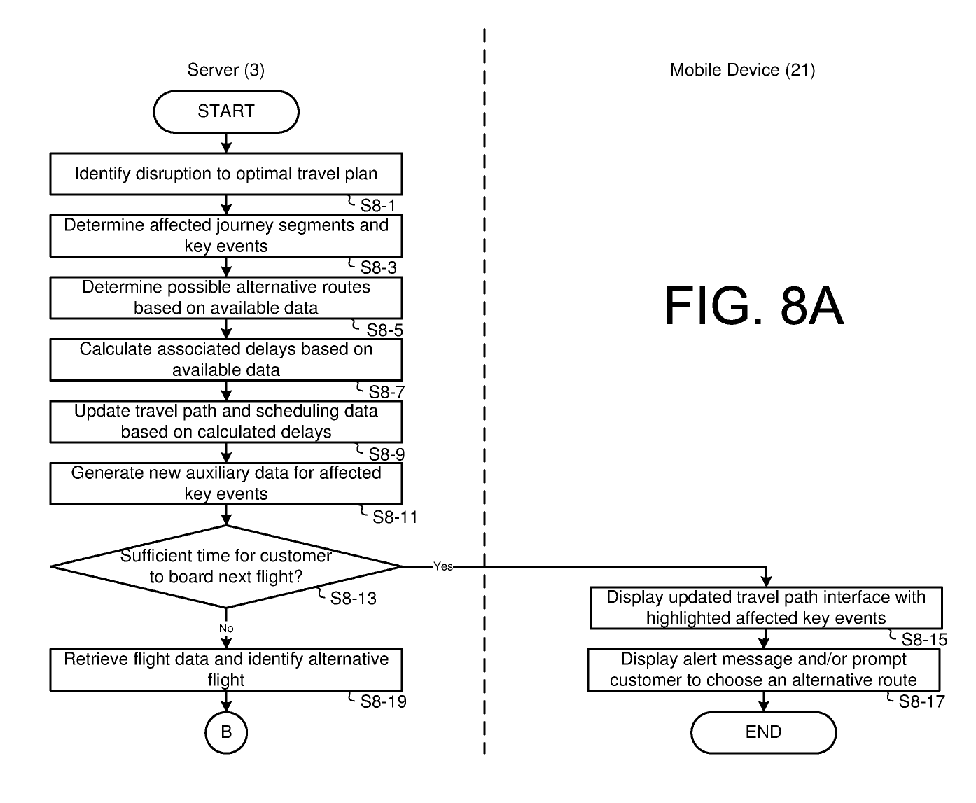

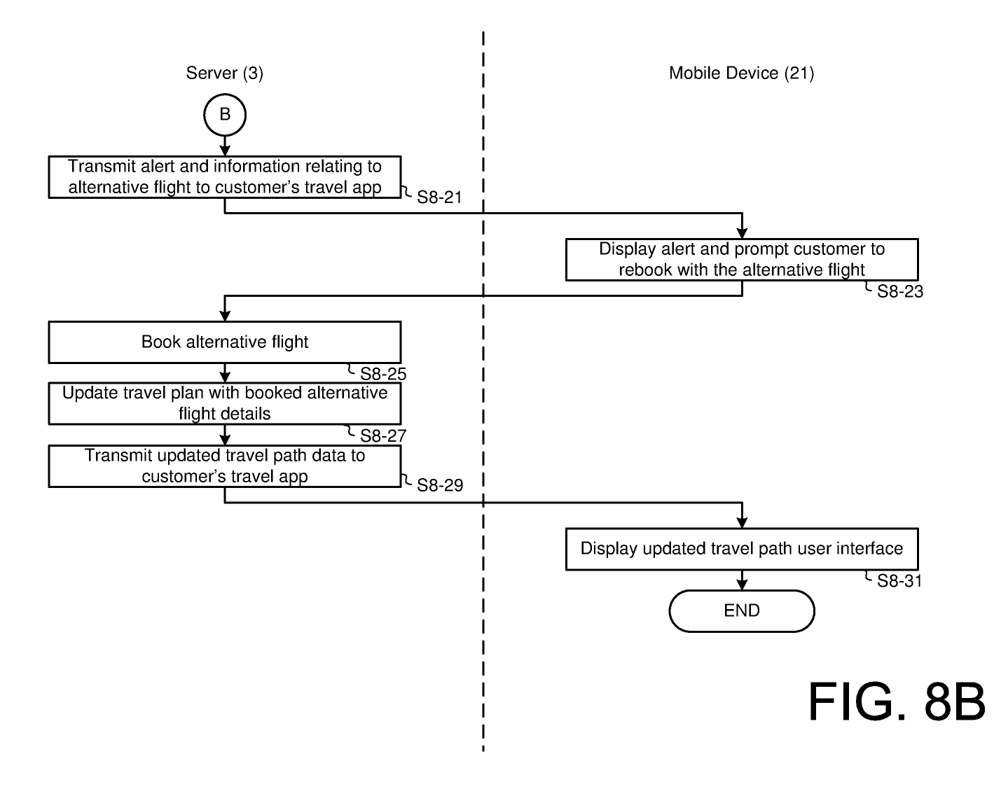

A description has been given above of the components forming part of the tracking and guidance system 1 of this embodiment. A detailed description of the operation of these components in this embodiment will now be given with reference to the flow diagrams of FIGS. 5 and 8, for an example computer-implemented dynamic travel path generation process using the server 3. Reference is also made to FIGS. 6, 7, 9 and 10, schematically illustrating exemplary dynamic travel paths displayed by the travel app 23 on the customer's mobile device 21.

As shown in FIG. 5, which comprises FIGS. 5A and 5B, the process begins at step S5-1 where the mobile device 21 loads the travel app 23, for example in response to a user command to launch the app. The travel app 23 may require the customer to login with pre-registered details. At step S5-3, the travel app 23 determines the geolocation of the mobile device 21, for example using the location signal receiver 39, and updates the server 3 with the customer's current geolocation. The travel app 23 may continue to update the server 3 at periodic intervals, via the mobile device tracking sub-module 73 of the travel app interface module 55.

At step S5-5, the travel path module 51 retrieves customer data 5 for the customer registered with the travel app 23, for example in response to a user command to display an interactive travel plan interface via the travel app 23. The retrieved customer data 5 includes information relating to the customer's next booked journey, such as details of the outbound and return flights that are booked for the journey, as well as the hotel reservation at the destination. At step S5-7, the travel app 23 displays an initial view of the interactive travel plan, including the retrieved information relating to the customer's next booked journey. Alternatively or additionally, a local copy of the retrieved customer data 5, flight data 7 and terminal data 9 may be stored by the travel app 23 on the mobile device 21, for efficient display of the dynamic travel path interface without requiring an initial or persistent data connection to the server 3.

FIG. 6 schematically illustrates one example of an initial view of the interactive travel path displayed by the travel app 23 on the customer's mobile device 21. In this example, the travel path is presented as a scrollable ribbon interface 101, with a horizontal dynamic time axis 103 indicating the location along the ribbon corresponding to the current time 105. The ribbon interface 101 may instead be displayed in a vertical orientation.

The customer data 5 includes information relating to a booked journey to Malibu, Calif., with an outbound flight departing today from London's Heathrow Airport and arriving at Los Angeles International Airport, displayed as a first raised segment 107-1 of the ribbon interface 101. The customer data 5 also includes information relating to the return flight in six weeks time, displayed as a second raised segment 107-2, with a corresponding indication on the time axis 103. The booked journey may also include details of a hotel reservation while the customer is at the destination, displayed as a lower segment 109-2 between the respective raised segments 107-1, 107-2. Similarly, a lower segment 109-1 precedes the raised segment 107-1 associated with the outbound flight, indicating that the customer was at a predefined home location, London, UK in this example. In this embodiment, the raised segments 107 correspond to in-flight segments of the customer's booked journey and the lower segments 109 correspond to ground segments of the journey.

The user can scroll the ribbon interface 101 along the horizontal axis, for example via user input 37, to view the customer's past and future booked journeys. As described later, each raised segment 107 of the ribbon interface 101 may be a user-selectable element of the interface in order to retrieve and view more data relating to the associated flight. Alternatively or additionally, the ribbon interface 101 may be configured to process user input commands to zoom into the travel path at a selected position to retrieve and view more data relating to the segment 107,109 at that position, and to zoom out to return to the previous or initial view.

In this embodiment, the server 3 is configured to plan and generate an optimal travel path for the customer's booked journey that can be displayed in an interactive travel path interface of the travel app 23. Accordingly, at step S5-9 in FIG. 5A, the travel path module 51 retrieves flight data 7 including information relating to the customer's next flight in the retrieved booked journey. At step S5-11, the travel path module 51 retrieves terminal data 9 including information relating to the departure and arrival airport terminals of the customer's next flight. At step S5-13, the travel path module 51 processes the retrieved data and determines a plurality of journey segments for the booked journey. The booked journey is processed into a plurality of high level journey segments, based on information relating to the outbound and return flights, such as time and date, flight number, carrier, airport, etc. Following from the example illustrated in FIG. 6, the high level segments include a plurality of in-flight segments 107 corresponding to discrete time periods when the customer is on-board a respective booked flight, and intervening ground segments 109 corresponding to discrete time periods between booked flights.

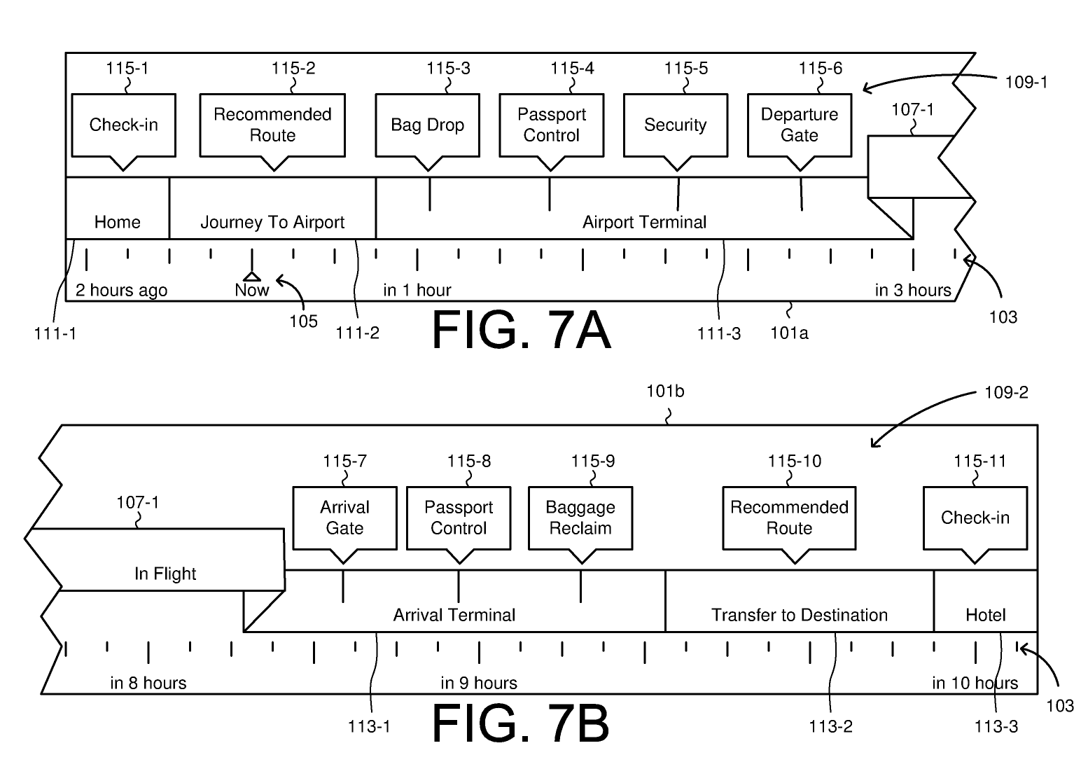

The travel path module 51 also processes each high level journey segment to determine a respective plurality of lower level journey segments, and to identify one or more defined and/or anticipated geographical locations associated with each lower level journey segment. FIG. 7, which consists of FIGS. 7A and 7B, schematically illustrates an example of a zoomed-in view of the interactive travel path displayed by the travel app 23. In this example, a first high level ground segment 109-2, prior to the customer's outbound flight from London to Los Angeles, is broken down into three discrete and sequential lower level segments 111, as illustrated in the first portion 101a of the ribbon interface in FIG. 7A. The first lower level segment 111-1 is associated with a discrete time period of the travel path when the customer is at a predefined home location, for example the customer's home city or home address. The second lower level segment 111-2 is associated with the subsequent time period of the travel path when the customer is, or should be, travelling to the departure airport terminal. The third lower level segment 111-3 is associated with the subsequent time period of the travel path when the customer is in the airport terminal.

Similarly, the high level ground segment 109-2 after the customer's outbound flight from London to Los Angeles is also broken down into three lower level segments 113, as illustrated in the second portion 101b of the ribbon interface in FIG. 7B. However, in this ground segment, the first lower level segment 113-1 is associated with the time period of the travel path when the customer is in the destination airport terminal, the second lower level segment 113-2 is associated with the subsequent time period when the customer will be travelling to the hotel in the destination city, and the third lower level segment 113-3 is associated with the subsequent time period when the customer arrives at the hotel. Each journey segment is associated with a respective time or time period along the time axis 103, which may be calculated relative to the current time 105, based on the retrieved and processed data.

The travel path module 51 can also determine one or more key events for respective high level and/or lower level journey segments. Each key event is also associated with a respective time or time period along the time axis 103, which may be calculated relative to the current time 105, based on the retrieved data. For example, as illustrated in FIG. 7A, the first lower level segment 111-1 of the first ground segment 109-1 includes a key event 115-1 associated with an earliest possible and/or recommended time for the customer to proceed with online check-in for the outbound flight. Although not illustrated, one or more key events may be determined for the passenger prior to online check-in, such as a reminder 24 hours before the scheduled flight. The second lower level segment 111-2 of the first ground segment 109-1 includes a key event 115-2 associated with a recommended route to the departure airport terminal, for example as determined by the travel path module 51 or by the travel app 23 based on the customer's current geo-location 29. The third lower level segment 111-3 of the first ground segment 109-1 includes a plurality of key events associated with respective stages that the customer must progress through the departure airport terminal, such as bag drop 115-3, passport control 115-4, security 115-5 before arriving at the departure gate assigned to the outbound flight 115-6.

Similarly, a plurality of key events 115 are determined for the second ground segment 109-2 as illustrated in FIG. 7B. The first lower level segment 113-1 of the second ground segment 109-2 includes a plurality of key events associated with respective stages that the customer must progress through the arrival airport terminal, such as the arrival gate assigned to the flight 115-7, passport control 115-8 and the baggage reclaim belt or area assigned to the flight 115-9. The second lower level segment 113-2 of the second ground segment 109-2 includes a key event 115-2 associated with a recommended route from the arrival airport terminal to the hotel at the destination. The third lower level segment 113-3 of the second ground segment 109-2 includes a key event associated with an anticipated time of check-in at the hotel, for example as calculated by the travel path module 51 or the travel app 23.

Referring back to FIG. 5B, at step S5-15 the travel path module 51 retrieves environment data, such as traffic, public transport and weather data, from predefined third-party data sources 25 via the respective environment data source interface modules 63, where the environment data is determined to be available for each identified geographical location. At step S5-17, the travel path module 51 determines the optimal travel path for the customer's journey and associated scheduling data for the lower level journey segments and associated key events, based on the determined availability of data such as environment data 25 for the geographical locations along the travel path, and airport terminal data 9.

As one example, the planning sub-module 53 may determine that the retrieved airport terminal data 9 includes information relating to the location of key entities within the departure and/or arrival airport terminals, such as bag drop area(s), passport control area(s), security check area(s), departure and arrival gates and baggage reclaim areas or belts, as well as associated routing and timing information between respective entities. Consequently, the planning sub-module 53 is able to utilise the available airport terminal information to accurately determine scheduling data for the customer's travel plan, for example within the airport terminal ground segments 111-3, 113-1 illustrated in FIG. 7, based on estimated travel time to the identified location of each key event 115 in the segment 111-3, 113-1. The planning sub-module 53 can also take into account estimated waiting time and/or duration of each key event 115, which may be calculated based on information defining average waiting times and/or based on information received from queue monitors 17 at the respective locations.

As another example, the planning sub-module 53 may determine that one or more public transport data sources 24-3 are available for the departure and/or destination locations of the customer's booked journey. The retrieved public transport data includes information relating to the location of boarding and alighting points of the public transport system, such as a bus or train station closest to the customer's home address and an alighting point at the airport terminal, as well as routing and timing information between respective points of the public transport system. Consequently, the planning sub-module 53 is able to utilise the available public transport information to accurately determine scheduling data for the customer's travel plan, for example for a determined route for the journey to/from airport ground segments 111-2, 113-2 illustrated in FIG. 7, based on estimated travel time along a determined route.

In this way, different tiers of dynamic travel paths can be determined for a customer's booked journey depending on available data sources associated with locations along the travel path, each tier having a different level of complexity and a corresponding degree of scheduling accuracy.

Referring again to FIG. 5B, at step S5-19, the travel path module 51 can identify key events that are associated with one or more predefined actions, and generate auxiliary data for the identified key events that can be displayed by the travel app 23 in response to a user command to select a respective key event 115 on the ribbon interface 101a. For example, auxiliary data can be generated for the recommended route key event 115-2 illustrated in FIG. 7A, defining step-by-step routing instructions from the customer's home or last-known geographical location to a car park area of the airport terminal if the customer is driving, or to a public transport alighting point if the customer is taking public transport. Alternatively, the auxiliary data may include an instruction to a planning sub-module (not shown) of the travel app 23 to determine and display a recommended route for the associated journey segment.

As another example, auxiliary data can be generated for each key event 115 of an airport terminal ground segment 111-3, including information relating to specific routing and timing information retrieved from the airport terminal data 9. The auxiliary data may be presented as a map of the airport terminal, indicating the customer's current or last known location within the terminal, and the recommended route and estimated travel time to the next key event. Alternatively or additionally, the auxiliary data may be presented as an augmented reality interface, superimposed on image data captured by the camera 49 of the mobile device 21.

As yet another example, auxiliary data may include a link to a website or an external mobile app, such as a flight online check-in website, a hotel website or app with information relating to the hotel reservation, a public transport website or app with additional route, time and map information, a dedicated map website or app, etc.

At step S5-21, the travel path module 51 transmits the optimal travel path data and auxiliary data to the travel app 23 on the customer's mobile device 21, via the travel app interface module 55. At step S5-23, the travel app 23 receives the data and displays the interactive travel path interface based on the received travel path data, including user-selectable key events 115 associated with the journey segments 111,113 of the optimal travel path. At step S5-25, the travel app 23 processes user interactions with the travel path 101 and key events 115 of the interface, for example to handle user commands to scroll and/or zoom the displayed portion of the travel path, and to retrieve and execute an action associated with a user selected key event 115.

In this embodiment, the system is configured to dynamically suggest adjustments to the travel path in response to identified disruptions. Accordingly, as shown in FIG. 8, which comprises FIGS. 8A and 8B, the process continues at step S8-1 where the disruption sub-module 54 of the travel path module 51 receives data from one or more third party data sources 25 and/or the processed airport terminal data 9, and identifies one or more disruptions to the optimal travel plan. For example, the disruption sub-module 54 can receive information relating to traffic flow incidents and delays from the traffic data source 25-1, severe weather forecasts and incidents from the weather data source 25-2, and public transport incidents and delays from the public transport data source 25-3. The disruption sub-module 54 can also receive information from one or more queue monitors 17 via the airport terminal data processing module 65 and/or from the airport terminal database 9.

At step S8-3, the planning sub-module 53 determines one or more affected journey segments 111,113 and/or key events 115 of the travel path generated for the customer's booked journey, based on the information relating to the identified disruptions from available data sources 25. At step S8-5, the planning sub-module 53 determines whether any alternative routing options are possible for the affected journey segments 111,113, based on the received information from available data sources. For example, the planning sub-module 53 may determine that alternative airport terminal facilities are available with shorter queues and waiting times, that a driving detour route is possible to avoid an identified traffic incident, that an alternative mode of public transport or routing is possible to avoid an identified public transport incident, etc.

At step S8-7, the planning sub-module 53 identifies and/or calculates associated time delays to the affected journey segments 111,113 and/or key events 115, based on the received information from available data sources. For example, the traffic delay information may indicate a delay of two hours due to an incident at a location along the recommended route to the airport terminal, or may identify a traffic jam between two locations along the route, from which the planning sub-module 53 may calculate an estimated delay to the route. As another example, the public transport delay information may indicate a delay of twenty minutes from an incident at a train station, or may identify a disruption to a service between two stations along the recommended route to the airport station or associated alighting point.

At step S8-9, the planning sub-module 53 and travel path module 51 update the optimal travel path data and associated scheduling data based on the calculated delays. At step S8-11, the travel path module 51 generates auxiliary data for any new and affected key events, for example including details of identified disruptions and/or suggested possible alternative routes. At step S8-13, the planning sub-module 53 determines whether or not the customer will have sufficient time to travel from the present or last-known geographical location to the assigned boarding gate in the departure airport terminal, taking into account the calculated delay from the identified disruption. If the planning sub-module 53 determines that the customer still has sufficient time to make the booked flight, then at step S8-15, the updated travel path data is transmitted to the travel app 23 and displayed to the customer with highlighted new and affected key events. At step S8-17, the travel app 23 may display an alert message defined by auxiliary data associated with the travel disruption key event and/or may prompt the user to select a suggested alternative route, for example in response to a user command to select the respective highlighted key event.

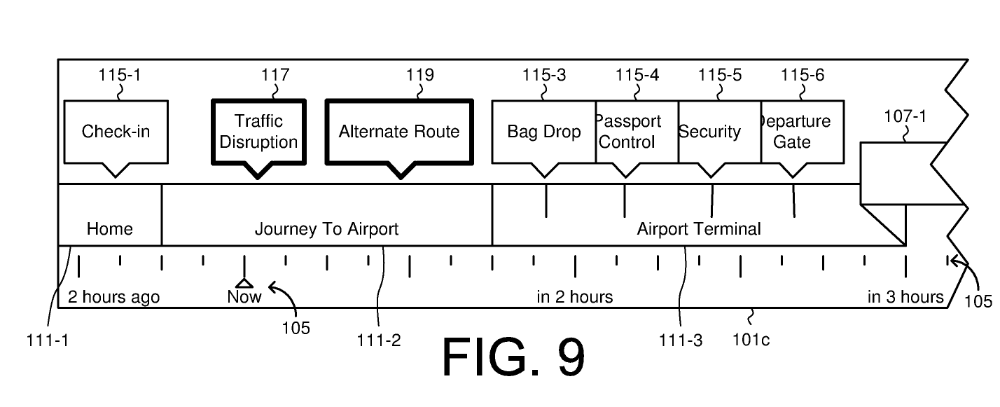

FIG. 9 schematically illustrates an example of a zoomed-in view of a ribbon interface 101c, displaying an updated version of the travel path in the ribbon interface 101a illustrated in FIG. 7A. In this example, an identified traffic disruption 117 is displayed as a new key event along the journey to the airport segment 111-2 of the travel path, which has added a delay of approximately 45 minutes to that affected segment. As a result, the length of the displayed segment 111-2 is now longer than the previous segment as illustrated in FIG. 7A, resulting in an anticipated arrival time to the airport terminal in just under two hours time, instead of one hour's time as illustrated in FIG. 7A. The identified traffic disruption does not affect the departure time of the customer's next flight. Accordingly, the displayed in-flight segment 107-1 of the travel path is displayed at the same relative position from the current time 105 as illustrated in FIG. 7A. However, the planning sub-module 53 has automatically compensated for the shorter time duration that the customer has within the airport terminal segment 111-3 by scheduling the associated key events 115-3 to 115-6 closer together, taking into account defined minimum time parameters associated each key event as well as available airport terminal information relating to respective key events, such as queue lengths and waiting times.

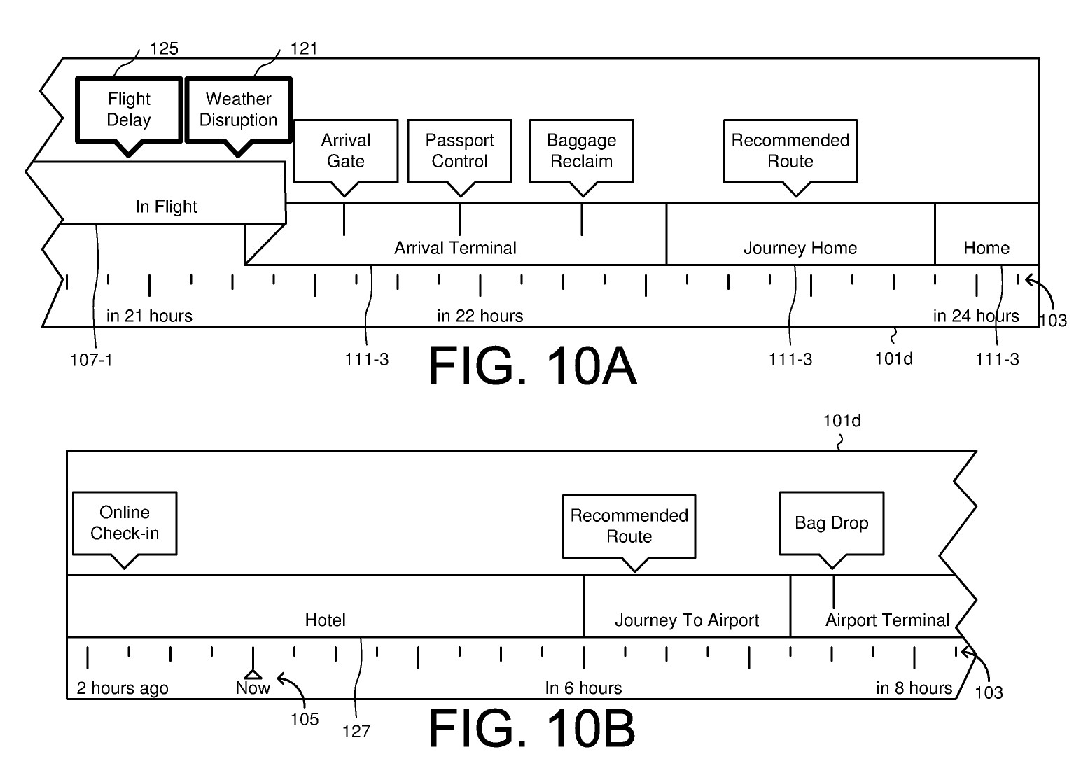

FIG. 10, which comprises FIGS. 10A and 10B, schematically illustrates a different example of a zoomed-in view of a ribbon interface 101d relating to the return flight of the customer's booked journey from Los Angeles to London. In this example, an identified weather disruption 121 is displayed as a new key event along the in-flight segment 123 of the travel path, which has caused a flight delay 125 of approximately 4 hours to that affected segment 123. As a result, the planning sub-module 53 has automatically compensated for the additional time duration that the customer has within the hotel ground segment 127 at the current time 105, by lengthening the displayed segment 127 and indicating that the customer need not set off for the departure airport terminal until six hours time.

Referring back to FIG. 8B, if on the other hand, the planning sub-module 53 determines at step S8-13 that the customer will not have sufficient time to travel to the assigned boarding gate in the departure airport terminal due to the identified disruption and calculated delay, then ate step S8-19, the planning sub-module 53 retrieves flight data 7 and identifies one or more alternative available flights that the customer can take to get to intended destination. At step S8-21, the travel path module 51 generates and transmits an alert to the customer's travel app 23, together with information relating to the alternative flight options available to the customer. At step S8-23, the travel app 23 displays the alert and prompts the customer to select an alternative flight for automatic re-booking. At step S8-25, the travel path module 51 receives the customer's selection via the travel app interface module 55, and instructs the flight booking module 57 to automatically book the new flight for the customer. The resulting Passenger Name Record (PNR) for the flight reservation is then stored in the customer data 5.

At step S8-27, the travel plan module 51 receives confirmation of the re-booking from the flight booking module 57 and updates the travel plan for the customer's revised booked journey with the information relating to the re-booked flight. At step S8-29, the travel plan module 51 transmits the updated travel path data to the customer's travel app 23, for display by the travel app 23 at step S8-31.

Computer System

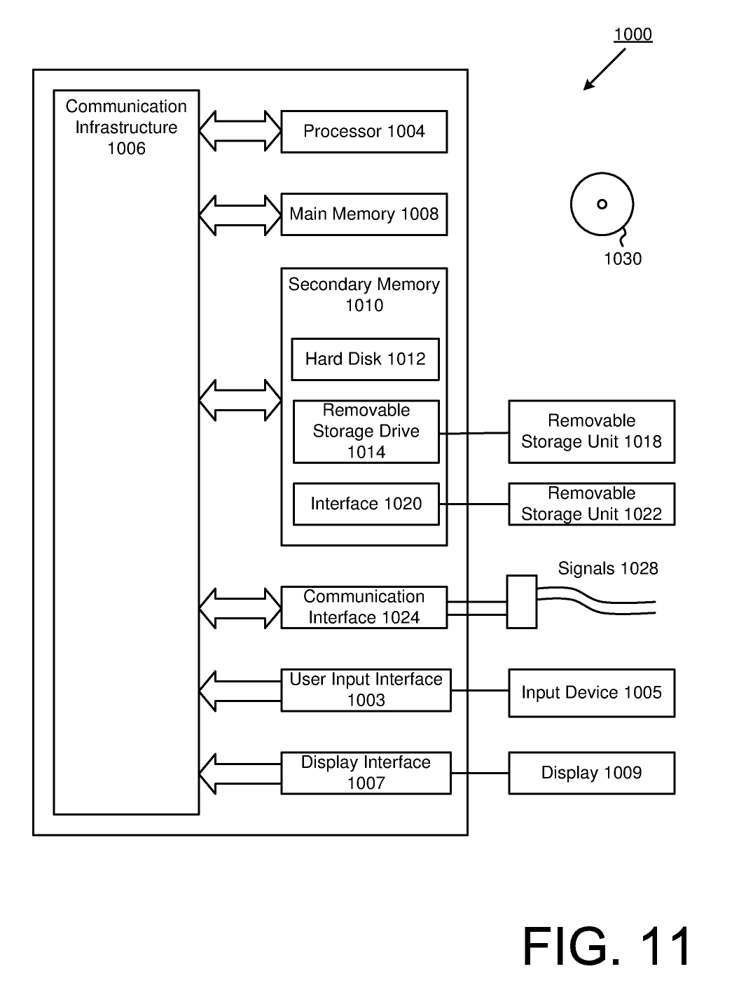

The tracking and guidance system described herein may comprise a computer system 600 as shown in FIG. 11. Embodiments of the present invention may be implemented as programmable code for execution by the computer system 600. Various embodiments of the invention are described in terms of this example computer system 600. After reading this description, it will become apparent to a person skilled in the art how to implement the invention using other computer systems and/or computer architectures.

Computer system 600 includes one or more processors, such as processor 604. Processor 604 may be any type of processor, including but not limited to a special purpose or a general-purpose digital signal processor. Processor 604 is connected to a communication infrastructure 606 (for example, a bus or network). Computer system 600 also includes a main memory 608, preferably random access memory (RAM), and may also include a secondary memory 610. Secondary memory 610 may include, for example, a hard disk drive 612 and/or a removable storage drive 614, representing a floppy disk drive, a magnetic tape drive, an optical disk drive, etc. Removable storage drive 614 reads from and/or writes to a removable storage unit 618 in a well-known manner. Removable storage unit 618 represents a floppy disk, magnetic tape, optical disk, etc., which is read by and written to by removable storage drive 614. As will be appreciated, removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that previously found in video game devices), a removable memory chip (such as an EPROM, or PROM, or flash memory) and associated socket, and other removable storage units 622 and interfaces 620 which allow software and data to be transferred from removable storage unit 622 to computer system 600. Alternatively, the program may be executed and/or the data accessed from the removable storage unit 622, using the processor 604 of the computer system 600.

Computer system 600 may also include a communication interface 624. Communication interface 624 allows software and data to be transferred between computer system 600 and external devices. Examples of communication interface 624 may include a modem, a network interface (such as an Ethernet card), a communication port, a Personal Computer Memory Card International Association (PCMCIA) slot and card, etc. Software and data transferred via communication interface 624 are in the form of signals 628, which may be electronic, electromagnetic, optical, or other signals capable of being received by communication interface 624. These signals 628 are provided to communication interface 624 via a communication path 626. Communication path 626 carries signals 628 and may be implemented using wire or cable, fibre optics, a phone line, a wireless link, a cellular phone link, a radio frequency link, or any other suitable communication channel. For instance, communication path 626 may be implemented using a combination of channels.

The terms “computer program medium” and “computer usable medium” are used generally to refer to media such as removable storage drive 614, a hard disk installed in hard disk drive 612, and signals 628. These computer program products are means for providing software to computer system 600. However, these terms may also include signals (such as electrical, optical or electromagnetic signals) that embody the computer program disclosed herein.

Computer programs (also called computer control logic) are stored in main memory 608 and/or secondary memory 610. Computer programs may also be received via communication interface 624. Such computer programs, when executed, enable computer system 600 to implement the present invention as discussed herein. Accordingly, such computer programs represent controllers of computer system 600. Where the invention is implemented using software, the software may be stored in a computer program product and loaded into computer system 600 using removable storage drive 614, hard disk drive 612, or communication interface 624, to provide some examples.

In alternative embodiments, the invention can be implemented as control logic in hardware, firmware, or software or any combination thereof. The apparatus may be implemented by dedicated hardware, such as one or more application-specific integrated circuits (ASICs) or appropriately connected discrete logic gates. A suitable hardware description language can be used to implement the method described herein with dedicated hardware.

### ALTERNATIVE EMBODIMENTS

The embodiments described above are illustrative of rather than limiting to the present invention. Alternative embodiments apparent on reading the above description may nevertheless fall within the scope of the invention.

For example, in the embodiment described above, the server determines the optimal travel path and associated scheduling data for display by the travel app. It will be appreciated that in an alternative embodiment, some of the processing steps performed by the travel path generator module and/or the planning sub-module in the above embodiment can instead or additionally be performed by the travel app. For example, the travel path generator module can be configured to generate data identifying the sequence of journey segments and associated key events and to include basic scheduling information relating to coarse estimations of timing and duration. In this alternative, the travel app can include a respective planning sub-module for dynamically updating the scheduling information and consequently the optimal travel path data, for example based on the current geo-location of the mobile device determined from the location signal receiver and/or from location data received from the server, and/or based on environment data and processed airport terminal data received from the server.

In the embodiment described above, the optimal travel path is displayed by the travel app on the customer's mobile device. In an alternative embodiment, the travel path and scheduling data may be automatically transmitted to a beacon when the customer or the associated mobile device interacts or comes into range of that particular beacon. In this way, the beacons can provide clear directional support to the customer for the next step or steps along the optimal travel path, including terminal map information and step by step travel directions. Additionally, the beacons may be configured to automatically determine the customer's preferred language, for example from the pre-registered customer data, and to display information and guidance instructions in the preferred language.

Alternative embodiments may be envisaged, which nevertheless fall within the scope of the following claims.

1. A system for dynamic travel path planning, comprising:
means for retrieving stored data defining a customer's journey from a departure location to a destination location, the journey including at least one scheduled flight to or from a configured airport terminal, wherein the configured airport terminal includes a plurality of customer locating means provided at respective locations of the configured airport terminal;
means for receiving planning data from a plurality of predefined data sources, including location data from a mobile device associated with the customer, location data from said plurality of customer locating means identifying a location of the customer in the configured airport terminal, and environment data from at least one external data source;
means for determining schedule data defining a dynamic travel path for the customer's journey based on received planning data, the dynamic travel path including a plurality of journey segments and key events along a timeline, each journey segment and key event associated with at least one timing parameter;
means for identifying a disruption to the dynamic travel path based on received planning data and for identifying one or more affected journey segments and key events of the dynamic travel plan;
means for updating the schedule data by adjusting the timing parameters of the affected journey segments and key events based on received planning data; and
means for outputting the schedule data as an interactive interface by the customer's mobile device.

2. The system of claim 1, wherein the customer locating means comprise a plurality of mobile device sensors and interactive display stations located throughout the airport terminal.

3. The system of claim 2, wherein the at least one database stores data identifying the plurality of mobile device sensors and interactive display stations, and a respective associated location.

4. The system of claim 2 or claim 3, wherein the mobile device sensors are configured to transmit data to the server in response to detection of the customer's mobile device by a sensor.

5. The system of claim 2 or claim 3, wherein the interactive display stations are configured to transmit data to the server in response to identification of the customer or the customer's mobile device interacting with a station.

6. The system of any preceding claim, wherein the environment data includes data relating to a specific geographical location or area.

7. The system of claim 6, wherein the environment data includes data relating to road traffic incidents and delays, public transport incidents and delays, and weather incidents.

8. The system of claim 6, wherein the environment data includes data relating to queue lengths and waiting times.

9. The system of any one of claims 6 to 8, wherein the means for updating the schedule data further comprises determining the availability of environment data for a geographical location associated with each journey segment of the optimal travel path, whereby accuracy of the schedule data depends on the determined availability of environment data.

10. The system of any preceding claim, wherein the timing parameters comprise an anticipated start time and duration.

11. The system of claim 10, wherein the server further comprises means for determining that the updated schedule data results in insufficient time for the customer to board the scheduled flight, and in response, for identifying an alternative flight.

12. The system of claim 11, wherein the server further comprises means for automatically rebooking the customer on the alternative flight, and wherein the updating means is operable to update the schedule data based on the rebooked flight.

13. The system of any preceding claim, wherein one of said journey segments is associated with a travel path from the departure location to the configured airport terminal for a scheduled flight.

14. The system of claim 13, wherein the server further comprises means for determining at least one suggested route for the journey segment.

15. The system of claim 14, wherein the at least one suggested route includes driving instructions from the departure location to the configured airport terminal.

16. The system of claim 14, wherein the at least one suggested route includes routing instructions using public transport from the departure location to the configured airport terminal.

17. The system of any preceding claim, wherein the server further comprising means for generating and transmitting auxiliary information to guide the customer from the departure location to a boarding gate at configured airport terminal assigned to the scheduled flight.

18. A system for dynamic travel path planning, comprising:
at least one database stored data defining a customer's journey from a departure location to a destination location;
a server apparatus in accordance with any one of claims 1 to 17, coupled to the at least one database.

19. A system for dynamic travel path planning for a customer's journey from a departure location to a destination location, comprising means for receiving location data identifying a geo-location of the customer and environment data from at least one external data source relating to the customer's current and anticipated geo-locations, and means for determining and updating schedule data defining a dynamic travel path for the customer's journey based on received location and environment data, based on selection of one of a plurality of tiered travel paths of varying complexity, depending on the availability of location and environment data at the customer's current and anticipated geo-locations.

20. A method of dynamic travel path planning, comprising:
retrieving data defining a customer's journey from a departure location to a destination location, the journey including at least one scheduled flight to or from a configured airport terminal, wherein the configured airport terminal includes a plurality of customer locating means provided at respective locations of the configured airport terminal;
receiving planning data from a plurality of predefined data sources, including location data from a mobile device associated with the customer, location data from said plurality of customer locating means identifying a location of the customer in the configured airport terminal, and environment data from at least one external data source;
determining schedule data defining a dynamic travel path for the customer's journey based on received planning data, the dynamic travel path including a plurality of journey segments and key events along a timeline, each journey segment and key event associated with at least one timing parameter;
identifying a disruption to the dynamic travel path based on received planning data and for identifying one or more affected journey segments and key events of the dynamic travel plan;
updating the schedule data by adjusting the timing parameters of the affected journey segments and key events based on received planning data; and
transmitting the schedule data to the customer's mobile device for display as an interactive interface.

21. A method of dynamic travel path planning for a customer's journey from a departure location to a destination location, comprising the processor-implemented steps of receiving location data identifying a geo-location of the customer and environment data from at least one external data source relating to the customer's current and anticipated geo-locations, and determining and updating schedule data defining a dynamic travel path for the customer's journey based on received location and environment data, based on selection of one of a plurality of tiered travel paths of varying complexity, depending on the availability of location and environment data at the customer's current and anticipated geo-locations.

22. A storage medium comprising machine readable instructions stored thereon for causing a programmable device to become configured as a system in accordance with any one of claims 1 to 19.
